(19) United States
(12) Patent Application Publication
(10) Pub. No.: US 2023/0167948 A1
(43) Pub. Date: Jun. 1, 2023

(54) SYSTEM FOR MONITORING THE FUNCTION OF A PRESSURE RELIEF VALVE OF A CRYOGENIC VESSEL ON A VEHICLE ROOF

(71) Applicants: Cryoshelter LH2 GmbH, Dobl-Zwaring (AT); Cryoshelter BioLNG GmbH, Dobl-Zwaring (AT)

(72) Inventor: Matthias REBERNIK, Dobl-Zwaring (AT)

(21) Appl. No.: 17/995,183

(22) PCT Filed: Mar. 3, 2021
(86) PCT No.: PCT/AT2021/060071

§ 371 Date: Sep. 30, 2022

(30) Foreign Application Priority Data
Mar. 31, 2020 (AT) A 50270/2020

(51) Int. Cl. F17C 13/02; B60K 15/07

(52) U.S. Cl. CPC F17C 13/025; B60K 15/07; F17C 2201/035; F17C 2201/056; F17C 2205/0314; F17C 2205/0332; F17C 2221/033; F17C 2223/0161; F17C 2223/033; F17C 2250/043; F17C 2260/021; F17C 2260/038; F17C 2260/042; F17C 2265/031; F17C 2270/0176

(57) ABSTRACT

The invention relates to a system for checking the function and releasing the excess pressure of a cryogenic container on a vehicle roof, the system comprising a vehicle and the cryogenic container which is mounted on the vehicle roof and has an interior volume for receiving cryogenic fluid, wherein the system furthermore comprises a pressure line which is connected to the interior volume of the cryogenic container and is led from the cryogenic container on the vehicle roof to an accessible point on the vehicle side or in the vehicle interior and opens into a pressure gauge there, wherein a valve and a predetermined breaking point are arranged in the pressure line and the valve is arranged between the predetermined breaking point and the interior volume of the cryogenic container and opens at a predetermined first pressure which is greater than a second pressure at which the predetermined breaking point breaks.

The invention relates to a system for checking the function and releasing the excess pressure of a cryogenic container on a vehicle roof, the system comprising a vehicle and the cryogenic container which is mounted on the vehicle roof and has an interior volume for receiving cryogenic fluid.

According to the prior art, liquefied gases can be stored in containers (“cryogenic containers”) so as to be stored as a fuel for an engine, for example. Liquefied gases are gases which are in a liquid state and have a temperature that is equal to or lower than the pressure-dependent boiling temperature of the gas in question at the prevailing gas pressure. If such a cryogenic liquid or cryogenic fluid is filled into a cryogenic container, a pressure corresponding to the boiling temperature is established, apart from thermal interactions with the cryogenic container itself. In particular, it must be ensured that the pressure in the cryogenic container does not become too high, since otherwise the cryogenic container might be permanently damaged or might even explode. Therefore, on each cryogenic container, at least one pressure control valve is arranged which releases cryogenic fluid from the cryogenic container when a threshold value is reached.

From EP 3 489 062 A1, it is known to mount a tank for holding a cryogenic fluid on a vehicle roof and to provide a pressure control valve next to the cryogenic container on the vehicle roof. The pressure control valve is activated when the pressure prevailing in the cryogenic container exceeds a threshold value and subsequently allows cryogenic fluid to flow from the cryogenic container in order to reduce the pressure. Since the pressure control valve on the vehicle roof is usually not visible to a user in or beside the vehicle, the above-mentioned document proposes that a sensor be provided which monitors the excess-pressure activation of the pressure control valve. If the sensor detects an excess-pressure activation of the pressure control valve, the sensor actuates a display device which indicates, e.g., by means of a warning light, that the pressure control valve has been activated.

However, the system described in the above-mentioned document has two drawbacks in particular. The first drawback is that the system described in the above-mentioned document requires a power source such as a battery so that the sensor can detect the activation of the pressure control valve and can subsequently send a signal to the display device via electrical connections. However, since all electrical components of the vehicle should be switched off especially during the filling process in order to avoid the creation of sparks when the cryogenic container is being filled, the battery or a different power source is counterproductive, since a signal should be sent when an activation of the pressure control valve is detected and, therefore, a current flow is required, which might cause sparks.

The second drawback is that the pressure control valve itself may have a defect. The pressure control valve of the above-mentioned document consists of an actual valve and a “red cap” as a visual indicator, which is arranged behind it and pops off already at a low pressure, i.e., hence, in any case, when the valve is activated. However, if there is a leak in the valve, the cap of the pressure control valve may accidentally become detached from it. As a result of the fact that the cap of the pressure control valve has popped off, an error message is thus issued by the display device without the user of the vehicle knowing whether the pressure control valve has actually been activated at the intended pressure.

The background to this problem is that usually two pressure control valves are provided for one cryogenic container, with the second pressure control valve being activated at a higher pressure than the first pressure control valve. The first pressure control valve is activated at a pressure which is reached on a regular basis, whereas the second pressure control valve is used as a backup for the first pressure control valve. If the second pressure control valve also fails to be activated, the cryogenic container will be damaged if the pressure rises further. Therefore, the red cap of the second pressure control valve is of great importance, because if it is missing, this may point to a malfunction of the first pressure control valve.

It is therefore the object of the invention to provide an alternative embodiment for indicating the activation of the pressure control valve. This alternative should have a particularly robust design so that the disadvantages of the prior art are overcome.

Said object is achieved by a system for checking the function and releasing the excess pressure of a cryogenic container on a vehicle roof, the system comprising a vehicle and the cryogenic container which is mounted on the vehicle roof and has an interior volume for receiving cryogenic fluid, wherein the system furthermore comprises a pressure line which is connected at one end to the interior volume of the cryogenic container and is led from the cryogenic container on the vehicle roof to an accessible point on the vehicle side or in the vehicle interior and, at its other end, has a pressure gauge there, and wherein a valve and a predetermined breaking point are arranged in the pressure line and the valve is arranged between the predetermined breaking point and the interior volume of the cryogenic container and opens at a predetermined first pressure which is greater than a second pressure at which the predetermined breaking point breaks. According to this arrangement, the predetermined breaking point is thus located between the valve and the pressure gauge so that the latter can measure and indicate the pressure between the valve and the predetermined breaking point.

This system has the advantage that, firstly, it can indicate an operating status of the pressure control valve completely without current. The information about the pressure control valve can be indicated by means of the pressure line led to the side of the vehicle or, respectively, the interior of the vehicle, without the need to lay separate electrical connections from a sensor to a display device.

With the system according to the invention, it is moreover possible to draw conclusions about other malfunctions of the valve in the pressure line, e.g., a leak. This is achieved in that the pressure indicator only measures the pressure in the pressure line, rather than an actual activation of the pressure control valve or a rupture of the predetermined breaking point. The pressure gauge thus allows conclusions to be drawn about a state of the pressure control valve without monitoring it itself by indirectly indicating a pressure.

In a preferred embodiment, the pressure gauge comprises a mechanical pressure indicator. This embodiment is particularly easy to implement in practice. In order to draw conclusions about the valve or, respectively, the predetermined breaking point from the indicated pressure, either markings can be located on the mechanical pressure indicator or appropriate information can be provided next to the mechanical pressure indicator. As an alternative to this, a user of the system can simply also deduce the state of the valve or, respectively, the predetermined breaking point from the displayed value of the mechanical pressure indicator, if the user is trained accordingly.

In a further preferred embodiment, the pressure gauge has a first display unit which indicates a first warning when a third pressure is reached, which is lower than the second pressure. This is not a continuous pressure display, but rather a pin, for example, which pops out as soon as the third pressure is reached. In this way, it can be indicated clearly that the third pressure has been reached without any interpretation or analysis required from the user. The issuing of the warning at the third pressure, which is lower than the second pressure, suggests that the valve is leaking or has been activated so that maintenance measures should be taken, such as, e.g., a replacement of the valve at a workshop.

In the aforementioned embodiment, it is particularly preferred if the pressure gauge has a second display unit which indicates a second warning when the fourth pressure is reached, which lies between the second and the third pressures. Especially when the fourth pressure is just below the first pressure at which the valve opens, the second warning may indicate that the valve might be open. The fourth pressure is chosen to be between the second and the third pressures, since the predetermined breaking point is also subject to a certain manufacturing tolerance and might possibly also be activated under a pressure corresponding to the second pressure.

Both the first and the second display units can preferably only manually be returned to a position in which they do not issue the first or, respectively, the second warning. This causes the warning to be issued until appropriate measures such as maintenance can be performed.

The above-mentioned embodiments are preferably configured in such a way that the pressure line and the pressure gauge are designed in such a way that, after the valve has been opened, no cryogenic fluid will escape at said point. As a result, it can be envisaged that cryogenic fluid escapes only via the predetermined breaking point. This embodiment is particularly relevant to safety since persons are usually present at said point who monitor the pressure gauge, fill the tank or perform other tasks.

In an alternative embodiment, the pressure line is fitted with a throttle and the pressure indicator comprises a rupture disc. For example, the rupture disc is designed to break at said third or fourth pressure, indicating to a user that a certain pressure has been reached. Although cryogenic fluid escapes from the pressure line after the rupture disc has broken, the leakage through the throttle can be reduced to such an extent that there is no danger to persons in the vicinity of the rupture disc.

According to the prior art, pressure control valves are sold in which a cap is provided on the atmospheric side of the valve. If the valve opens, the cap pops off as well and allows the cryogenic fluid to escape there. If the cap is missing, the user concludes that the valve has been activated. According to the invention, a cap for the predetermined breaking point is provided also in the present system. Although the predetermined breaking point could perhaps be designed in a technically simpler way, users are already accustomed to the cap and might continue to conclude that the valve has been activated if the cap is missing also in case of the invention. In addition, there is the advantage that the system is easier to maintain, since caps for pressure control valves are already available and therefore no new type of predetermined breaking point has to be created.

In a further preferred embodiment, the pressure indicator is accessible next to a filling coupling. This has the advantage for the user that he or she can always keep an eye on the pressure indicator during the filling process. In particular, the user should know whether the tank is in a safe condition before refuelling is started. This information is also relevant to the user before each start-up, which can be checked easily and quickly by means of the display according to the invention. The information is particularly relevant if the vehicle with the cryogenic container has not been put into operation for an extended period of time, e.g., for several days.

In principle, the location of the attachment of the predetermined breaking point on the vehicle can be chosen freely, taking into account the safety-relevant circumstances. Particularly preferably, the predetermined breaking point is arranged on the vehicle roof, since, in this case, cryogenic fluid escapes only in directions in which no people are present. However, as an alternative to this, the predetermined breaking point can also be arranged on the side of the vehicle and can release cryogenic fluid in the direction of the vehicle roof when the predetermined breaking point is broken. In further alternative embodiments, the predetermined breaking point could also be attached at a different location and could, for example, guide released cryogenic fluid via a line to a safe place such as the vehicle roof in order to discharge the cryogenic fluid into the environment there.

Advantageous and non-limiting embodiments of the invention are explained in further detail below with reference to the drawings.

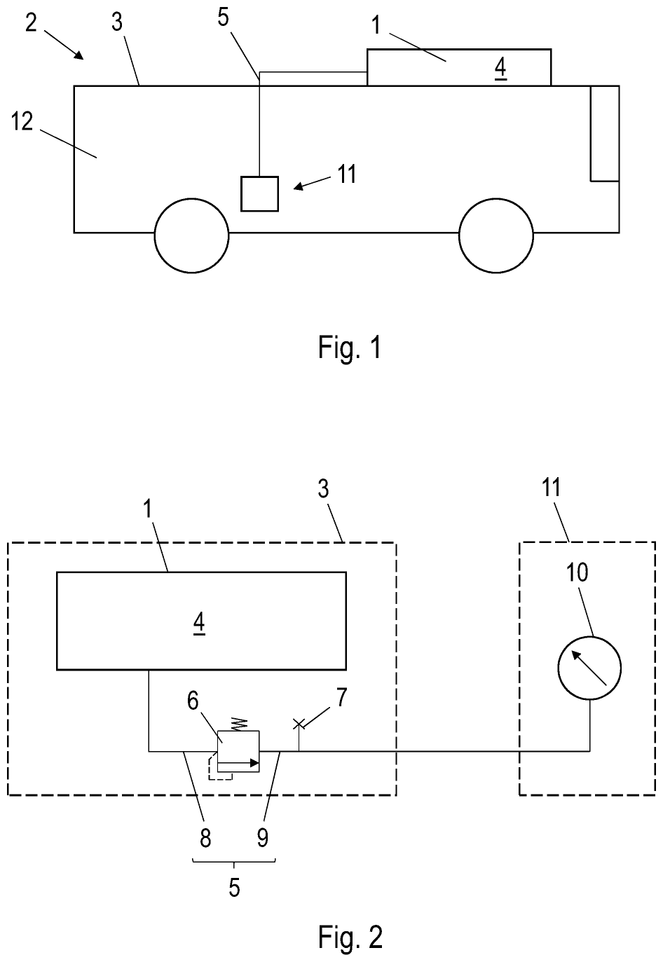

FIG. 1 shows a vehicle with a cryogenic container mounted on the vehicle roof.

FIG. 2 shows a block diagram of the system according to the invention.

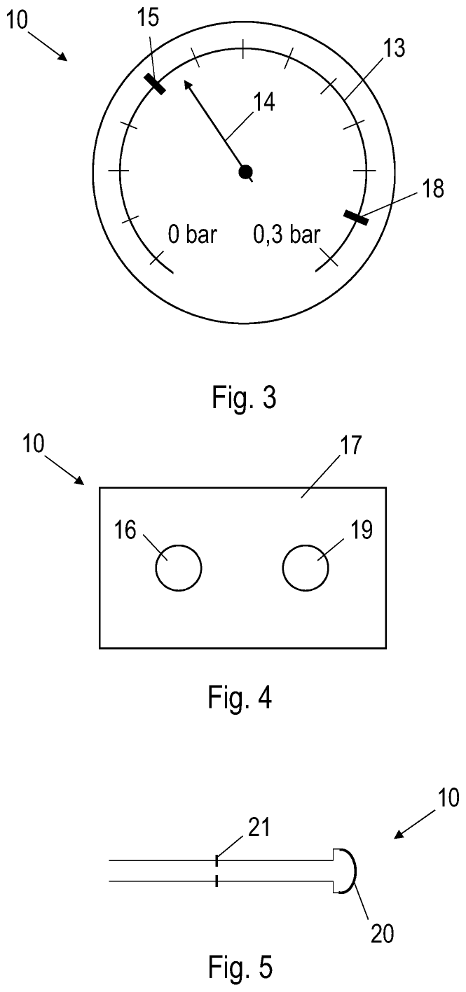

FIG. 3 shows the pressure gauge according to the invention in a first embodiment.

FIG. 4 shows the pressure gauge according to the invention in a second embodiment.

FIG. 5 shows the pressure gauge according to the invention in a third embodiment.

FIG. 1 shows a cryogenic container 1 and a vehicle 2, with the cryogenic container 1 being mounted on the vehicle roof 3. The fluid stored in the inner container 4 of the cryogenic container 1 is, for example, liquefied natural gas, also known to those skilled in the art as LNG (“Liquid Natural Gas”). The fluid usually exists in liquid form up to a filling level, and beyond that in a gaseous state, so that the term “cryogenic fluid” is used also in this case. Typically, the fluid serves as a fuel for an engine of the motor vehicle 2, for which purpose the cryogenic container 1 can be connected to the engine of the vehicle 2 by means of an extraction line.

The vehicle 2 can be designed as a low-floor vehicle, for example. In general, it must be ensured that the vehicle 2 with the cryogenic container 1 mounted thereon does not exceed a certain height so that the installation space located on the vehicle is limited. A valve assembly by means of which lines connected to the cryogenic container 1 can be closed and opened, respectively, is usually installed next to the cryogenic container 1 on the vehicle roof 3. In particular, this includes pressure control valves which are connected to the interior of the cryogenic container 1 and discharge fluid in the gaseous state from the cryogenic container 1 as soon as the pressure in the cryogenic container 1 exceeds a predetermined threshold value.

From the prior art, it is known to arrange a sensor beside the pressure control valve, which usually is not visible easily, so that the sensor detects when the pressure control valve opens. Thereupon, the sensor can send a warning via electrical connections to a display device, which is located at a place that is easier to access. In contrast to this, the invention can do without a sensor which would be located next to the pressure control valve or, respectively, next to a cap of the pressure control valve, as described below with reference to FIG. 2.

According to the invention, a pressure line 5 is connected to the cryogenic container 1 so that cryogenic fluid can enter into the pressure line 5 from the interior volume 4 of the cryogenic container 1. The pressure line 5 is connected to the cryogenic container 1 in such a way that cryogenic fluid enters into the pressure line 5 in a gaseous phase.

The purpose of the pressure line 5 is that cryogenic fluid can be discharged from the cryogenic container 1 when the pressure in the cryogenic container 1 exceeds a threshold value. Two pressure control valves are generally connected to the cryogenic container 1, with the first pressure control valve having a threshold value that is lower than the threshold value of the second pressure control valve. The pressure line 5 with its components, which is presented herein, is primarily supposed to replace the pressure control valve with the higher threshold value, although it may be envisaged that the pressure line 5 can also be used instead of the pressure control valve with the lower threshold value.

According to FIG. 2, a valve 6 and a predetermined breaking point 7 are located in the pressure line 5. Both the valve 6 and the predetermined breaking point 7 are usually provided on the vehicle roof 3, but they can also be installed at a different place. It is a characteristic of the valve 6 that it opens as soon as the pressure on the side 8 of the pressure line 5 which is pressurized and faces the cryogenic container 1 exceeds a threshold value which corresponds to a first pressure of, for example, 16 bar or 22 bar. As a result, cryogenic fluid can flow from the inner container 4 through the pressurized side 8 and the valve 6 to the atmospheric side 9 of the pressure line 5 and can be discharged into the environment there, as explained in further detail below.

The pressure line 5 is thus divided by the valve 6 into two separate areas, the pressurized side 8 on the one hand and the atmospheric side 9 on the other hand. In the pressurized side 8, there is a pressure which corresponds to the pressure in the inner container 4 of the cryogenic container 1. As long as the valve 6 is completely and tightly closed, a pressure exists in the atmospheric side 9 which corresponds to the atmospheric pressure, which is referred to below as 0 bar overpressure. In addition, it is also possible to deaerate the atmospheric side 9 with a “reset button”, thus resetting the pressure in the atmospheric side 9 to 0 bar overpressure, so as not to misinterpret unavoidable minimum leaks that may add up over quite some time.

The pressure line 5 can be designed in such a way that it has the same diameter on either side of the valve 6. However, it may also be envisaged, in particular, that the pressure line 5 has a smaller diameter on the atmospheric side 9, at least following the predetermined breaking point 7.

The atmospheric side 9 of the pressure line 5 opens into a pressure gauge 10 on the side facing away from the valve 6. The pressure gauge 10 is located at a point 11 which is accessible on the vehicle side 12 or in the vehicle interior. For example, the pressure gauge 10 can be accessible beside a filling coupling on the vehicle side 12 so that a person filling up the cryogenic container 1 can always keep an eye on the pressure gauge 10. However, the pressure indicator could also be accessible on a dashboard in the driver's cab of the vehicle 2 so that the driver can see the pressure indicator immediately when entering the vehicle 2. The pressure line 5 could also branch off into two subsections on the atmospheric side 9 and exhibit one pressure gauge each at the ends of the two subsections so that one of the pressure gauges 10 on the vehicle side and one of the pressure gauges 10 in the vehicle interior are accessible. The pressure gauge 10 usually also includes the unit for measuring the pressure. If not, said unit is mounted at least on the pressure line 5 at the point 11 and is connected to the pressure gauge 10.

The pressure gauge 10 can indicate the pressure prevailing in the atmospheric side 9, for example, on a continuous scale, and, for this purpose, it can be designed as a mechanical pressure indicator in one embodiment (FIG. 3). Alternatively, the pressure indicator 5 can also be designed in such a way that it indicates a first warning when a specific pressure is reached, and, optionally, it can issue a second warning when a different specific pressure is reached (FIG. 4). These embodiments are explained in detail below.

In order to allow the cryogenic fluid to flow out of the atmospheric side 9 as soon as the valve 6 opens when the first pressure is reached, the pressure line 5 has the predetermined breaking point 7, which is located between the valve 6 and the pressure gauge 10. The predetermined breaking point 7 can be formed, for example, by a cap, which may have a signal colour. Caps are usually designed in red. However, instead of a cap, the predetermined breaking point can also be designed as a simple flap or an additional pressure control valve in the pressure line 5.

The predetermined breaking point 7 is usually arranged on the vehicle roof 3, but could also be arranged on the vehicle side 12 and could be designed in such a way that it discharges cryogenic fluid only in a direction which is not dangerous to people standing beside the vehicle 2, i.e., in the direction of the vehicle roof 3, that is, upwards or obliquely upwards.

The predetermined breaking point 7 breaks at a second pressure, which is usually 0.3 bar, but can generally also be between 0.1 and 2 bar. It is evident that the predetermined breaking point 7 breaks at a pressure which is well below the first pressure. The safety-relevant component is therefore the valve 6 and not primarily the predetermined breaking point 7. According to the prior art, it is therefore common that the activation of the pressure control valve can be inferred when a cap is no longer present on the pressure control valve. However, it has been shown that the valve 6 can leak. This increases the pressure to such an extent that the cap pops off and a state critical to safety is thus indicated, but it is unclear as to whether this was due to a leak not critical to safety or whether this was due to the fact that the first pressure had actually been reached, which was critical to safety. In the second case, different actions are required than in the first case, which vary widely in terms of follow-up costs.

Using the pressure pipe 5 that has been provided, it is possible, according to the invention, to determine by means of the pressure gauge 10 on the atmospheric side 9 of the pressure pipe 5 as to whether the valve 6 is leaking, regardless of the rupture of the predetermined breaking point 7. In one example, a pressure of 0 bar usually exists in the atmospheric side 9 of the pressure pipe 5, and the predetermined breaking point 7 breaks at the second pressure of 0.3 bar. However, if the pressure gauge 10 indicates that a pressure of 0.1 bar prevails in the pressure pipe 5 instead of a normal pressure of 0 bar, a leak in the valve 6 can be inferred. In this case, it is recommended to take the vehicle to a repair shop so that the valve 6 can be replaced or repaired.

This pressure of, for example, 0.1 bar, at which a leak in the valve 6 can be inferred, is referred to as the third pressure. For example, the third pressure can be 10%-50% of the second pressure. In order to easily identify that this threshold value has been reached, the pressure gauge, as illustrated in FIG. 3, can be designed as a mechanical pressure indicator which comprises a continuous scale 13 and a pointer 14, the pointer 14 indicating the respective current pressure in the atmospheric side 9 of the pressure pipe 5 on the scale. A marking 15 can be placed at the point of the scale 13 at which the third pressure is reached. If the pointer 14 of the mechanical pressure indicator exceeds the marking 15, it can be concluded that there is a leak in the valve 6 or, if applicable, that the valve 6 has been activated.

FIG. 4 shows a further embodiment for indicating that the third pressure has been reached. In this case, there is no continuous scale, but a first display unit 16 indicates whether the third pressure has been reached or not. For example, a pin can be received in a housing 17 of the pressure gauge 10 when the third pressure has not yet been reached and can protrude from the housing 17 as soon as the third pressure has been reached. The protrusion of the pin from the housing 17 thus constitutes a warning that the third pressure has been reached. Because of the warning of the first display unit 16, it can be concluded that there is a leak in the valve 6 or, if applicable, that the valve 6 has been activated.

Such solutions for indicating a first warning when the third pressure is reached can be designed purely mechanically and therefore without current. Light signals are used for indicating the first warning only in rare cases, since they require a certain current flow, which entails a safety risk.

With the discussed embodiments for indicating the third pressure, which is far below the second pressure of breaking the predetermined breaking point 7, it is thus possible to indicate as to whether the valve 6 is leaking. To give an indication as to whether the predetermined breaking point 7 has broken, the mechanical pressure indicator of FIG. 3 can have a second marking 18 at a fourth pressure, or, respectively, the pressure gauge 10 of FIG. 4 can have a second display unit 19, e.g., a second pin protruding from the housing 17, for indicating a second warning when a fourth pressure is reached.

The fourth pressure corresponds to the second pressure or is just below the second pressure at which the predetermined breaking point 7 breaks. For example, the fourth pressure is 80%-99% of the second pressure. The reason why the fourth pressure should be lower than the second pressure is that the predetermined breaking point 7 could be subject to a certain fault tolerance and, therefore, the second pressure would never be reached in the event of the predetermined breaking point 7 breaking prematurely. This is, in turn, due to the fact that, when the valve 6 opens, the pressure in the atmospheric side 9 of the pressure line 5 rises rapidly until the predetermined breaking point 7 breaks, and thereafter the pressure in the atmospheric side 9 of the pressure line 5 actually drops to atmospheric pressure, i.e., an overpressure of 0 bar.

In summary, in the embodiment of FIG. 3, the conclusion can thus be drawn that the valve 6 is leaking without rupture of the predetermined breaking point 7, if the pointer 14 is located between the first marking 15 and the second marking 18. If the pointer 14 indicates a pressure above the second marking 18, the conclusion can be drawn that the predetermined breaking point 7 has already broken or is about to break. It is not directly possible to indicate as to whether the valve 6 has been activated, because, in that case, the pointer 14 would indicate a pressure of 0 bar overpressure. To solve this problem, the mechanical pressure indicator may have a drag pointer, for example, which indicates the maximum pressure that has been reached. If the pointer 14 is at 0 bar overpressure, but the drag pointer is behind or on the second marking 18, the conclusion can be drawn that the valve has been activated without the valve 6 itself or the predetermined breaking point 7 having to be monitored for this.

In the embodiment of FIG. 4, it can be concluded that there is a leak in the valve 6 without rupture of the predetermined breaking point 7, if the first display unit 16 issues a warning, but not the second display unit 19. If both display units 16, 19 indicate a warning, either it can be concluded that the predetermined breaking point 7 has already broken or is about to break, or it can be concluded that the valve 6 has been activated. Also with this solution, the valve 6 itself or the predetermined breaking point 7 does not have to be monitored and all the components can have a purely mechanical design so that also this solution works without current.

The display units 16, 19 preferably remain in the warning position, even if the pressure should fall below the third or, respectively, the fourth pressure. In this embodiment, the display units 16, 19 can be returned to their original position in which they do not indicate a warning, using the above-mentioned reset button or a different reset button. Alternatively, at least one of the display units 16, 19 could be automatically brought to its original position as soon as the pressure in the atmospheric side 9 drops below the third or, respectively, the fourth pressure.

In both embodiments of FIGS. 3 and 4, fluid does not exit at the above-mentioned point 11, but only through the predetermined breaking point 7.

In FIG. 5, a section of the atmospheric side 9 of the pressure line 5 in an alternative embodiment is illustrated. In this case, the pressure gauge 10 is formed by a rupture disc 20. The rupture disc 20 can break, for example, at the above-mentioned third or fourth pressure. The fact that the rupture disc 20 breaks indicates that the valve 6 is either leaking or has been activated at the first pressure without the valve 6 itself or the predetermined breaking point 7 having to be monitored for this. A throttle 21 is provided in the atmospheric side 9 of the pressure line 5 in order to ensure that not too much cryogenic fluid escapes at the point 11 where the rupture disc 20 is visible. However, since cryogenic fluid always escapes after the rupture disc 20 has broken, the pressure at which the rupture disc 20 breaks is preferably chosen to be as close as possible to the second pressure at which the predetermined breaking point 7 breaks.

According to the invention, it is also possible to guide an electrical signal away from the pressure gauge 10 or, respectively, to have the latter activate a magnetic switch in order to display a signal in the driver's cab, for example. As a result, critical states can be indicated also while driving. Alternatively or additionally, the electrical signal or the activation of the magnetic switch could also have the effect that the engine is prevented from starting once the pressure in the pressure gauge reaches the third or fourth pressure.

Moreover, it should be mentioned that the valve 6 is usually activated at a predetermined differential pressure between the pressure in the pressurized side 8 and the pressure in the atmospheric side 9. For example, if the maximum pressure allowed in the cryogenic container 1 is 22 bar and the predetermined breaking point breaks at 1 bar, in each case relative to atmospheric pressure, the valve 6 should be set to be activated at a differential pressure of 21 bar. With this setting, the system can discharge fluid from the cryogenic container 1 if there is a pressure of 22 bar in said container. Of course, this setting option is also possible for other pressure ranges and is not limited to 22 bar or, respectively, 1 bar.

1. A system for checking the function and releasing the excess pressure of a cryogenic container on a vehicle roof, the system comprising a vehicle and the cryogenic container which is mounted on the vehicle roof and has an interior volume for receiving cryogenic fluid,
characterized in that
the system furthermore comprises a pressure line which is connected at one end to the interior volume of the cryogenic container and is led from the cryogenic container on the vehicle roof to a point accessible on the vehicle side or in the vehicle interior and there at its other end has a pressure gauge there,
wherein a valve and a predetermined breaking point are arranged in the pressure line and the valve is arranged between the predetermined breaking point and the interior volume of the cryogenic container and opens at a predetermined first pressure which is greater than a second pressure at which the predetermined breaking point breaks.

2. A system according to claim 1, wherein the pressure gauge comprises a mechanical pressure indicator.

3. A system according to claim 1, wherein the pressure gauge has a first display unit which indicates a first warning when a third pressure is reached, which is lower than the second pressure.

4. A system according to claim 3, wherein the pressure gauge has a second display unit which indicates a second warning when the fourth pressure is reached, which corresponds to the second pressure or lies between the second and the third pressures.

5. A system according to claim 1, wherein the pressure line and the pressure gauge are designed in such a way that, after the valve has been opened, cryogenic fluid will escape only at the predetermined breaking point.

6. A system according to claim 1, wherein the pressure line is fitted with a throttle and the pressure indicator comprises a rupture disc.

7. A system according to claim 1, wherein the predetermined breaking point is a cap.

8. A system according to claim 1, wherein the pressure indicator is accessible next to a filling coupling.

9. A system according to claim 1, wherein the predetermined breaking point is arranged on the vehicle roof.

10. A system according to claim 1, wherein the predetermined breaking point is arranged on the side of the vehicle and releases cryogenic fluid in the direction of the vehicle roof when the predetermined breaking point is broken.
